(19) United States
(12) Patent Application Publication
(10) Pub. No.: US 2003/0126053 A1
(43) Pub. Date: Jul. 3, 2003

(54) System and method for pricing of a financial product or service using a waterfall tool

(76) Inventors: Jonathan Boswell, Hunt Valley, MD (US); Govind Narayan, Richmond, VA (US); Dahren Grady, Hopewell Jct, NY (US); Shawn Parks, Forest, VA (US); Oscar Tengtio, Richmond, VA (US); Troy Thompson, Forest, VA (US)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(21) Appl. No.: 10/028,284

(22) Filed: Dec. 28, 2001

(51) Int. Cl. G06F 17/60

(52) U.S. Cl. 705/36

(57) ABSTRACT

A system and method for analyzing a financial services pricing process. The method includes the steps of receiving data in at least one input file of a pricing process summary tool from at least one data source and generating a waterfall based on the data received. The step of generating the waterfall includes measuring predetermined pricing metrics using the received data, and graphing the predetermined pricing metrics. The waterfall identifies the present value of each of the predetermined pricing metrics in relation to others of the predetermined pricing metrics.

### BACKGROUND OF THE INVENTION

The invention relates generally to pricing financial services products, and more particularly to reviewing financial services pricing processes.

The fastest and most effective way for a company to realize its maximum profits is to price its products and services effectively. The right price can increase a company's profits faster than increasing sales volume will. Studies have shown that improvements in price typically have 3 to 4 times the effect on a company's profitability as proportionate increases in volume. There are many products and services for which consumers may be willing to pay higher prices because of the desirability of such products and services. However, there are pricing points above which consumers will become unwilling to pay to obtain the products or services. Knowing how the pricing process can be optimized would be beneficial to sellers of a product/service.

Price management issues tend to fall into 3 distinct areas. The first area is “industry supply and demand.” At this highest level of price management, the basic laws of economics come into play. Changes in supply (e.g., new competitors), demand (e.g., demographic shifts, emerging substitute products), and costs (e.g., new manufacturing technologies) have significant effects on industry price levels.

The second area of price management is “product market strategy.” The central issue in this area is how consumers perceive the benefits of products/services across available suppliers. If a particular product/service delivers more benefit to consumers, then the company can usually charge a higher price versus its competition. The trick is to understand what features of the product/service consumers perceive as important, how the company's products/services stack up against its competitors' products/services, and how much consumers are willing to pay for the superior product/service.

The third area of price management is management of prices at the “transaction” level. The critical issue here is to determine how to manage the exact price charged for each transaction or order. In other words, what base price to use, what discounts/allowances may apply, what rebates may apply, and what incentives and bonuses may apply.

Where concern at the other two levels of price management is directed to the broad, strategic positioning of products/services in the marketplace, focus at the transaction level of price management is microscopic—consumer by consumer, transaction by transaction, deal by deal.

The objective of transaction price management is to achieve the best net realized price for each order or transaction. However, the complexity and volume of transactions tend to create a smokescreen that may make it impossible for the company's management to understand what is actually happening at the transaction level. Management information systems often do not report on transaction price performance, or may report only average prices and thus may not illuminate pricing opportunities lost on a transaction by transaction basis. Moreover, many companies only report on final invoice price related to the original base price (i.e., whether discounts or allowances applied, etc.). In most businesses, however, particularly those selling through agents, brokers, or other intermediaries, final invoice price does not reflect the true transaction price. A host of additional factors may come into play between the set invoice price and the final transaction cost, for example, prompt payment discounts, volume buying incentives, commissions and bonuses payable to sales brokers and agents, and cooperative advertising allowances. When you subtract the income lost through transaction-specific elements such as these from invoice price what is left is called the “pocket price,” in other words, the revenues which are left in the company's pocket as a result of a transaction. This “pocket price,” rather than the invoice price, is a more appropriate measure of the pricing attractiveness of a transaction. However, managers often fail to focus on pocket price because accounting systems do not collect information on many of these off-invoice discounts on a transaction basis. Moreover, since financial products and services are not commodities, the correct pricing points can be even more difficult to establish for such prices and services.

Other drawbacks may also exist in connection with conventional pricing systems and processes.

### BRIEF SUMMARY OF THE INVENTION

It is therefore desirable to address the drawbacks in conventional transaction level pricing systems and processes in connection with financial products and/or services.

A system and method for analyzing a financial services pricing process is provided. The method includes the steps of receiving data from a plurality of sources in a tool; and generating a waterfall. The step of generating the waterfall includes the sub-steps of measuring predetermined pricing metrics using the received data, and graphing the predetermined pricing metrics. The waterfall identifies the present value of each of the predetermined pricing metrics in relation to others of the predetermined pricing metrics.

In another aspect, a system for analyzing a financial services pricing process is provided. The system comprises means for receiving data from a plurality of sources in a tool; and means for generating a waterfall. The means for generating a waterfall includes means for measuring a plurality of predetermined pricing metrics using the received data, and means for graphing the predetermined pricing metrics. The waterfall identifies a present value of each of the predetermined pricing metrics in relation to others of the predetermined pricing metrics.

### BRIEF DESCRIPTION OF THE DRAWINGS

FIG. 1 is a block diagram illustrating one embodiment of a system for analyzing a financial services pricing process in accordance with the present invention;

FIG. 2 is a block diagram illustrating one embodiment of a financial services system;

FIG. 3 is a block diagram illustrating one embodiment of a waterfall tool for use with a system of the present invention;

FIG. 4 is a block diagram illustrating one embodiment of a waterfall-dashboard of the waterfall tool of FIG. 3;

FIG. 5 is a chart illustrating one embodiment of a waterfall according to the present invention;

FIG. 6 is a chart illustrating one embodiment of an underwriting worksheet according to the system and process of the present invention;

FIG. 7 is a chart illustrating one embodiment of a discount and a rider worksheet according to the system and process of the present invention;

FIG. 8 is a chart illustrating one embodiment of a commission worksheet according to the system and process of the present invention;

FIG. 9 is a chart illustrating one embodiment of a channel allowance worksheet according to the system and process of the present invention;

FIG. 10 is a chart illustrating one embodiment of a bonus worksheet according to the system and process of the present invention;

FIG. 11 is a screen shot illustrating one embodiment of the product-price tool of FIG. 4;

FIG. 12 is a screen shot illustrating one embodiment of the bonus schedule tool of FIG. 4;

FIG. 13 is a flow diagram illustrating the steps performed in one embodiment of a method for analyzing a financial services pricing process according to the present invention; and

FIG. 14 is a chart illustrating a control plan according to the system and process of the present invention.

### DETAILED DESCRIPTION OF THE INVENTION

Reference will now be made in detail to the present preferred embodiments of the invention, examples of which are illustrated in the accompanying drawings in which like reference characters refer to corresponding elements.

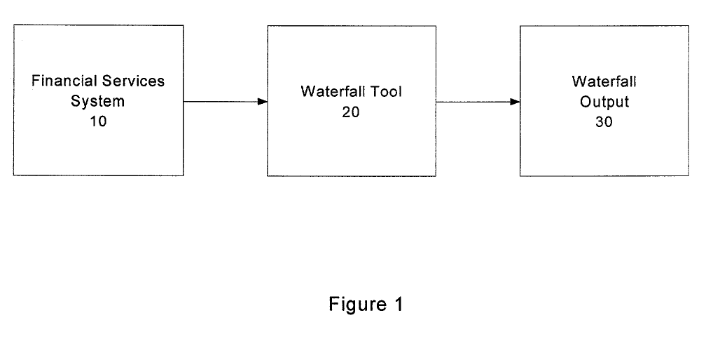

The present invention is described in relation to systems and methods for analyzing a financial services product pricing process. FIG. 1 is a block diagram illustrating one embodiment of a system for analyzing a financial services pricing process according to the present invention. The system may include a financial services system 10, a waterfall tool 20 and a waterfall output 30. Waterfall tool 20 is a tool which can be used to show revenues cascading down from a base list price to an invoice price and then to a pocket price. Each element of price structure represents a revenue “leak”. The waterfall tool 20 may be used to manage revenue leaks and thereby enhance price performance. The financial services system 10 may include one system or a plurality of systems. The waterfall tool 20 may receive inputs from the financial services system 10 to generate the waterfall output 30 illustrating revenue “leaks”. The waterfall tool 20 and the waterfall output 30 are shown in FIG. 1 to be outside of the financial services system 10. However, the waterfall tool 20 and the waterfall output 30 may be a part of the financial services system 10 in one embodiment.

In one embodiment, the waterfall tool 20 may be located at a remote site from the financial services system 10. In such an embodiment, the located waterfall tool 20 may be linked to the financial services system 10 through a communications link. The communications link may include or interface to any one or more of the Internet, an intranet, a Personal Area Network (PAN), a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1 or E3 line, a Digital Data Service (DDS) connection, a Digital Subscriber Line (DSL) connection, an Ethernet connection, an Integrated Services Digital Network (ISDN) line, a dial-up port such as a V.90, a V.34 or a V.34 bis analog modem connection, a cable modem, an Asynchronous Transfer Mode (ATM) connection, a Fiber Distributed Data Interface (FDDI), or a Copper Distributed Data Interface (CDDI) connection. The communications link may also include or interface to any one or more of a Wireless Application Protocol (WAP) link, a General Packet Radio Service (GPRS) link, a Global System for Mobile Communication (GSM) link, a Code Division Multiple Access (CDMA) link, a Time Division Multiple Access (TDMA) link such as a cellular phone channel, a Global Positioning System (GPS) link, a Cellular Digital Packet Data (CDPD) link, a Research in Motion, Limited (RIM) duplex paging type device, a Bluetooth radio link, or an IEEE 802.11-based radio frequency link. The communications link may further include or interface to any one or more of an RS-232 serial connection, an IEEE-1394 (Firewire) connection, a Fibre Channel connection, an infrared (IrDA) port, a Small Computer Systems Interface (SCSI) connection, a Universal Serial Bus (USB) connection or another wired or wireless, digital or analog interface or connection.

If the financial services system 10 and the waterfall tool 20 are linked by the communications link, each of the financial services systems 10 and the waterfall tool 20 may include a server for transmitting and receiving data. The financial services system 10 may also include a workstation running a Microsoft Windows™ NT™ operating system, a Windows™ 2000 operating system, a Unix operating system, a Linux operating system, a Xenix operating system, an IBM AIX™ operating system, a Hewlett-Packard UX™ operating system, a Novell Netware™ operating system, a Sun Microsystems Solaris™ operating system, an OS/2™ operating system, a BeOS™ operating system, a MacIntosh operating system, an Apache operating system, an OpenStep™ operating system or another operating system or platform.

The waterfall output 30 may include a graphical representation of a plurality of predetermined price metrics as well as drill down metrics of the predetermined price metrics themselves. The waterfall output 30 may be used to review a pricing process and identify opportunities to avoid revenue leaks, generate additional revenues, and thereby realize higher profits.

In one embodiment, the waterfall output 30 may be used to illustrate a waterfall for an insurance product, such as a life insurance product. The waterfall output 30 may include any number of predetermined price metrics. The waterfall may be defined at an insurance policy level. For a life insurance product, all of the life insurance policies put in force during a given period of time may be collected and used to generate the waterfall output 30. This allows the waterfall output 30 to have drill down capability to understand a root cause of trends that are identified with respect to transaction pricing of the specific life insurance product.

The waterfall tool 20 may be updated and reviewed at one or more predetermined time intervals. In one embodiment, the waterfall tool 20 may be reviewed and updated on a quarterly basis. Assessments may be made and actions taken during the review and updating of the waterfall tool 20.

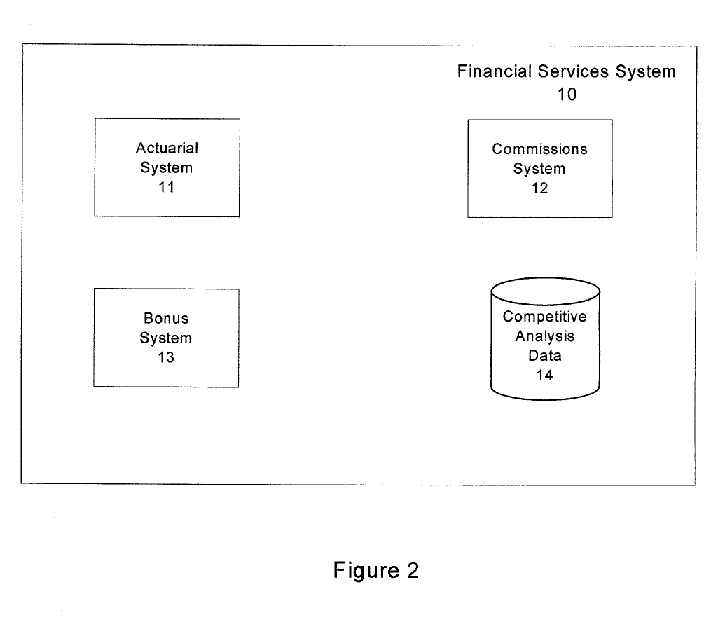

FIG. 2 is a block diagram illustrating one embodiment of the financial services system 10. The financial services system 10 may include an actuarial system 11, a commission system 12, a bonus system 13 and a competitive analysis system 14. In one embodiment, the competitive analysis system 14 may include a competitive analysis database. In one embodiment, each of the systems 11-13 may also include a database.

The systems 11-14, within the financial services system 10, may include pricing process related data to be input into the waterfall tool 20. Although the actuarial system 11, the commission system 12, the bonus system 13 and the competitive analysis database 14 are shown to be within the same financial services system 10, each of these systems 11-14 may be in a separate financial services system 10, according to another embodiment. In the other embodiment, the financial services system 10 may include other systems having data that may be input into the waterfall tool 20.

In one embodiment, life insurance policy information may be obtained from the actuarial system 11, commissions data may be obtained from the commissions system 12, bonus information may be obtained from the bonus system 13 and market data may be obtained from the competitive analysis system 14.

The data obtained from the actuarial system 11 may be divided into a plurality of fields. The fields for the data obtained from the actuarial system 11 may include at least one of a policy number, a company name, a subphase, a status, a system plan code, an issue date, an alternate issue date on which a particular life insurance policy was issued, a class, an age of an insured person under the life insurance policy, a sex of the insured person, a face amount of the life insurance policy, a channel through which the life insurance policy was sold (i.e., via an insurer or via an agent or a broker via the Internet), a mode, a gross annualized premium payable by the insured person to the insurer to maintain the life insurance policy in force, an amount of a substandard premium, and a premium amount payable for a rider.

In one embodiment, the subphase field may indicate whether an insurance policy has a rider or not. A rider may be a document which amends the life insurance policy. In one embodiment, the rider may increase the amount of premiums paid for the insurance policy in order for the insured person to obtain some special or additional coverage or benefits. The information included in the status field may indicate whether or not the rider is in force. The information included in the system plan code field may indicate a term of the insurance policy, such as a 20 year term or a 30 year term, or whether the policy is discounted. The information included in the issue date field may include a date on which the insurance policy is effective and coverage starts. The class field may indicate a risk class such as a preferred best risk class, or a preferred risk class, etc. of a policyholder or insured person for the insurance policy (i.e., a nonsmoker with no health-related problems). The information included in the mode field may indicate a frequency in which premiums are payable and the information included in the gross annualized premium field may include a total amount of premiums payable in a year, including any premiums payable for riders.

In one embodiment, the data obtained from the commissions system 12 may be divided into a plurality of fields. The fields of the data from the commissions system 12 may include an identification (“ID”) number for each of the agents selling the insurance policy product, an annual commission level to be paid on all sales of the insurance policy products made by agents or brokers for the insurer, a policy ID number, a plan type, and a paid date. The information included in the plan type field may include the type of insurance policy product sold such as, for example, a 20 year term life insurance policy, or a 30 year term life insurance policy. The information included in the paid date field may include a last date on which a commission to the agent was paid. The commission data field may also include a mode field indicating a frequency of commission payments.

In one embodiment, data obtained from the bonus system 13 may be divided into a plurality of fields including at least one of a company ID number field for a number identification of a company for an agent or broker selling the insurance policy product, a name of the company field to identify the name of the company selling the insurance policy product, a bonusable commissions field, a qualifying commissions fields, and a bonus paid field to indicate an amount of bonuses paid through a predetermined period. Data obtained from the bonus system 13 may also include a current institution roll-up map. A highest level of the current institution roll-up map may indicate a level of sales at which a bonus will be paid. In one embodiment, collection of a new current institution roll-up map from the bonus system 13 allows the waterfall tool 20 to use all current company identifications and commissions payable on sales in generating the waterfall output 30.

In one embodiment, the data obtained from the competitive analysis data system 14 may include market data regarding competitors or other institutions. In one embodiment, market data from the competitive analysis system 14 may be grouped into a plurality of data fields including a competitor name, a product type, a risk class, a premium band illustrating a plurality of premiums at which a specific insurance policy product has been sold, a rate, an average rate, and a commission. The rate field may include a price of an insurance policy product of the competitor. The average rate field may include an average price of all of the competitors' insurance policy field products sold. The market data may also be obtained from sources other than the competitive analysis system 14.

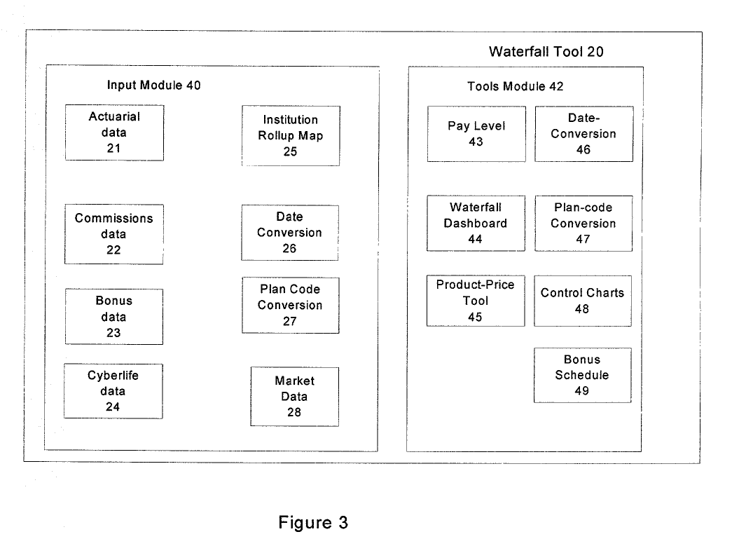

FIG. 3 is a block diagram illustrating one embodiment of the waterfall tool 20. The waterfall tool 20 may include an input module 40 and a tools module 42. In one embodiment, the input module 40 may be comprised of a database such as an Oracle™ relational database, an Informix™ database, a Database 2 (DB2) database, a Sybase database, an On Line Analytical Processing (OLAP) database, a Standard Query Language (SQL) database, a storage area network (SAN) database, a Microsoft Access™ database or other similar databases.

The input module 40 may include a plurality of files for accepting data from the financial services system 10. The files may include an actuarial data file 21, a commissions data file 22, a bonus data file 23, and a market file 28. The actuarial data file 21 may accept actuarial data from the actuarial system 11. The commissions data file 22 may accept commissions data from the commissions system 12. The bonus data file 23 may accept bonus data from the bonus system 13. The market file 28 may accept market data from the competitive analysis system 14.

The input module 40 may also include an institution roll-up map file 25, a date conversion file 26 and a plan code conversion file 27. The institution roll-up map file 25 may accept the institution roll-up map data collected from the bonus system 13. The date conversion file 26 may be a spreadsheet file used to convert dates given in an actuarial format into predetermined time identifications. For example, the date conversion file may convert dates given in an actuarial format into a plurality of months and quarters. The plan code conversion file 27 may be a spreadsheet file used to convert plan codes from the actuarial data obtained from the actuarial system 11 into a product name stored with the plan code in a database.

In one embodiment, there may be eight separate input files 21-28 used to develop the waterfall output 30. All of the input files 21-28 may be linked into the input module 40. In one embodiment, the input module 40 may be a Microsoft Access™ database. The data within the Access™ database may be manipulated to generate the waterfall and metrics of the waterfall output 30.

Database queries may be designed to sort the data received from the financial service system 10 into a format needed for the waterfall output 30. In one embodiment, the database queries may include an “all data” query, a “commission” query, a “rider” query, a “product” query, an “agency” query, and a “bonus level” query.

The “all data” query may be designed to run through the various linked databases and put all of the information needed into one area. In one embodiment, the “all data” query may be linked to all data except the market data which may be queried separately. Most of the other queries may be built off the data obtained via the “all data” query.

A “volume” query may be used to sort out sales volumes through each of the different premium bands. Within each premium band, the sales may be sorted by a product, a class, an age and/or a gender of the insured person. The volume queries may be linked with the market database to calculate a total market gap.

The commission queries may be used to calculate commissions payable on an insurance product policy level. A first commissions query may be used to calculate a commissionable premium for each insurance policy product subtracting out a service fee and a modal fee (for payment plans). A second commissions query may calculate the commissions to be paid for each of the individual insurance policy products sold. A third commissions query may be used to obtain a sum of the total commissions paid and the amount for each individual insurance policy product type.

In one embodiment, a rider may be available for each of the insurance policy products sold. For example, a life insurance policy may have a child rider, a spouse rider and/or a waiver rider available. A rider query may be used to calculate a monthly product rate of riders. A first rider query may be used to determine an amount of an annualized premium and a number of riders sold in that month. A second rider query may be used to sum a total number of riders sold for a year to-date and a total amount of premiums for a year to-date.

In one embodiment, specific queries may be available for each rider type. For example, waiver rider queries may be executed in one embodiment. Waiver rider queries may be used to sort waiver riders into monthly sales figures. A first waiver rider query may be used to sort all waiver riders from the regular insurance policy products. A second waiver rider query may be used to sort the total waiver rider sales within a month. A third waiver rider query may be used to calculate a total premium and count for an entire period.

An individual insurance policy product query may be used to separate out regular insurance policy products from riders by an individual insurance policy product. For example, an individual product query may calculate a sum of the premiums for a certain insurance policy product for a specific month including riders and the numbers of that insurance policy product type sold in a particular month. A total insurance policy product query may be used to sort a monthly production of the regular insurance products including a rider type. For example, the total insurance policy product query may sum the premiums for all of the regular insurance policy products sold including riders for a certain month and the number of the regular insurance policy products including riders sold in that month.

In one embodiment, the individual product query and the total product query may be used to separate spouse riders from other products. A first spouse rider query may separate the spouse rider by the individual product. A second spouse rider query may be used to sort the monthly production for spouse riders.

An all agency query and a bonus level query may be used to sort out commissions paid to individual agencies or departments. The all agency query may be used to match an institution ID number with the institution roll-up map 25 so that it is possible to tell which agency or department belong under which. The bonus level query may be used to sort and sum all of the agencies at the bonus level.

The tools module 42 may include a pay level tool 43, a waterfall dashboard 44, a product-price tool 45, a date conversion tool 46, a plan code conversion tool 47, a control charts 48, and a bonus schedule tool 49. The waterfall dashboard 44 may be used to generate the actual charts for the waterfall output 30. Waterfall dashboard 44 may be a spreadsheet file, such as, for example, a Microsoft Excel™ file. The control charts 48 may be used to generate control charts for the individual buckets or metrics of the waterfall output 30. The control charts 48 may be a Mini-tab™ file. The product-price tool 45 may be used to generate a market dashboard. The product-price tool 45 may be a spreadsheet, such as, for example, a Microsoft Excel™ spreadsheet.

The pay level tool 43 may be a spreadsheet file that sorts all of the separate departments or agencies or sub-companies (hereinafter, “departments”) within the company performing the waterfall analysis into their bonus pay levels. For example, the company performing the waterfall analysis (hereinafter, “the company”) may be comprised of an insurance company including a plurality of agents or other sub-companies selling insurance policies or insurance related products.

The institution roll-up map 25 may be pasted into the pay level tool 43 to create the file. In one embodiment, the spreadsheet file may be a Microsoft Excel™ file. In one embodiment, the institution roll-up map 25 may be pasted into the Excel™ file, and the columns preceding where the institution roll-up map 25 is pasted may be used to calculate the level at which bonuses were paid for each individual department ID number. Once the file is created, the file may be saved as a comma separated variable file (“.csv”). The file may be then imported into a database, such as an Access™ database.

The date conversion tool 46 may also be an Excel™ worksheet used to convert dates given in the actuarial format into months and quarter. The current year may be entered into one column and the dates may be automatically updated. Once the dates are updated with the current year, the file may be saved as a .csv file for importing into the Access™ database.

The plan code conversion tool 47 may also be a spreadsheet file, such as, for example, an Excel™ file. The plan code conversion tool 47 may be used to convert actuarial product names into simple product names that may be recognized. The Excel™ file from the plan code conversion tool may be updated as the product names change. The Excel™ file from the plan code conversion tool 47 may then be saved in a .csv format to be read into the Access™ database.

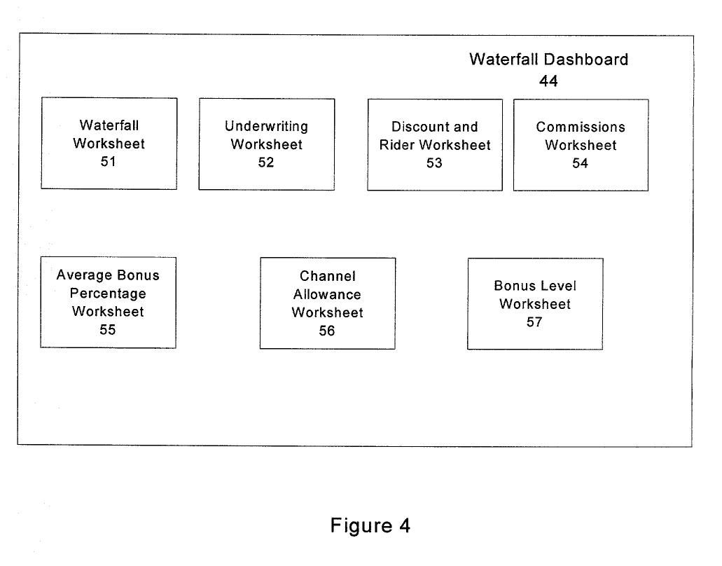

The waterfall dashboard 44 may be a spreadsheet workbook used to generate the waterfall and all the pricing metrics. In one embodiment, the waterfall dashboard may be an Excel™ workbook. The waterfall dashboard 44 will be described in more detail with reference to FIG. 4.

FIG. 4 is a block diagram illustrating one embodiment of the waterfall dashboard 44 according to the present invention. The waterfall dashboard 44 may include a waterfall worksheet 51, an underwriting worksheet 52, a discount and a rider worksheet 53, a commissions worksheet 54, an average bonus percentage worksheet 55, a channel allowance worksheet 56 and a bonus level worksheet 57.

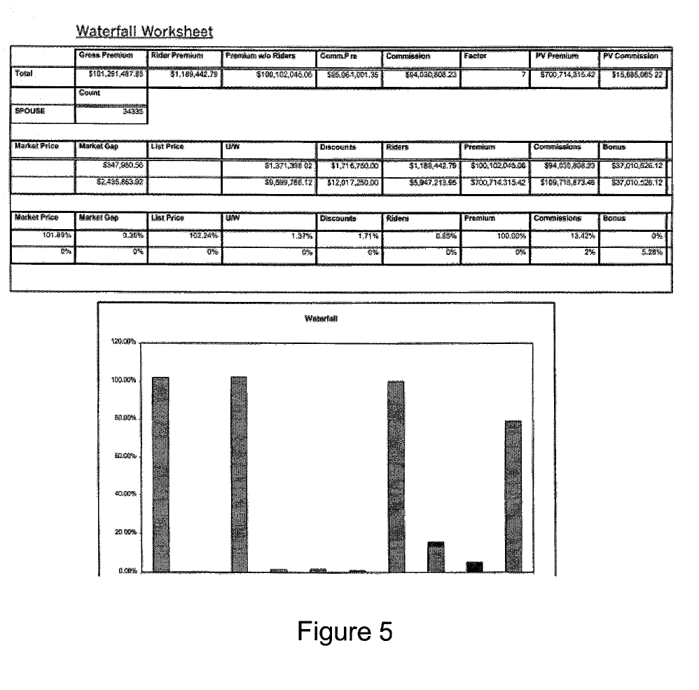

The waterfall worksheet 51 may be used to calculate a plurality of waterfall buckets or the predetermined pricing metrics and produce the waterfall graph for the waterfall output 30. FIG. 5 is an illustration of one embodiment of the waterfall worksheet 51 according to the present invention. A plurality of database queries, such as, for example, Microsoft Access™ formatted database queries, may be performed to obtain data to generate the waterfall graph and calculate the waterfall buckets. As shown in the chart of FIG. 5, the data obtained from the database queries may include a total gross annualized premium, a total annualized premium from riders, a commissionable premium amount, a total commissions paid amount, a total number of spouse discounts, and an amount of a market gap. This information may be pasted into the waterfall worksheet 51 from the database. The waterfall worksheet 51 may then calculate the values for each bucket or metric to generate the bar graph shown in FIG. 5. The pricing metrics calculated may include a market price, a market gap, a list price, an underwriting, a discount amount, a rider amount, a premium, a commission amount, and a bonus amount.

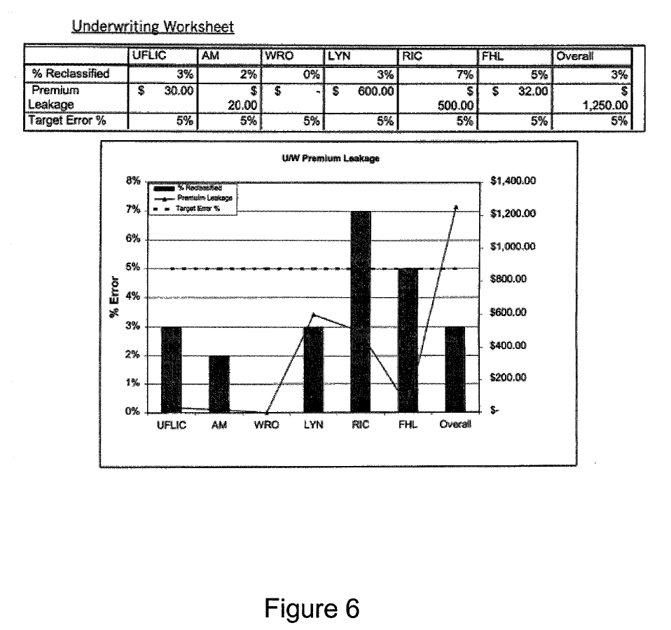

The underwriting worksheet 52 may be used to generate an underwriting dashboard. FIG. 6 is an illustration of one embodiment of the underwriting worksheet 52 according to the present invention. Data received from an underwriting committee may be directly typed into the underwriting worksheet 52. The underwriting worksheet 52 may be designed to show underwriting information for individual sites and for the overall company. The underwriting worksheet 52 may include a plurality of fields for such as a percent of policies reclassified, a premium (or revenue) leakage amount, and an information error percentage, as shown in FIG. 6. A graph 602 may be generated from the underwriting worksheet 52 to illustrate the premium leakage. In one embodiment, the graph 602 may illustrate the premium leakage for a product at each of the individual sites or departments within the company and the overall company.

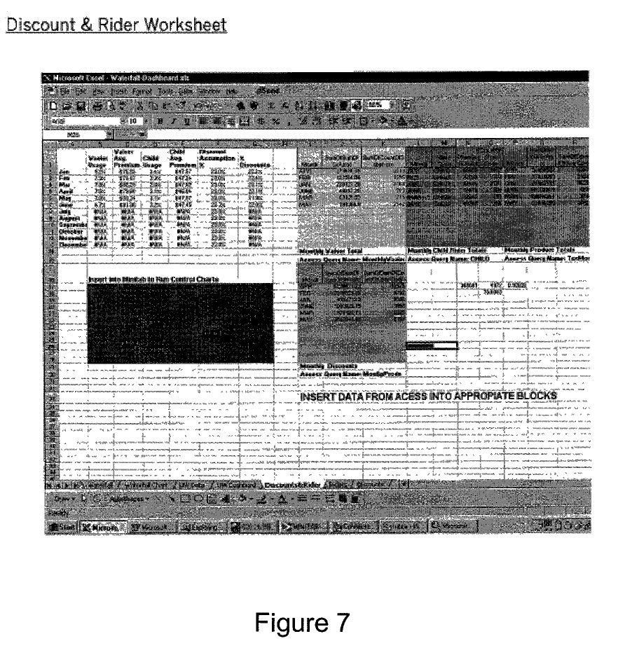

The discount and rider worksheet 53 may produce a dashboard for discounts and riders. FIG. 7 is a screen shot illustrating one embodiment of a discount and rider worksheet 53 according to the present invention. Output from database queries may be placed into the discount rider worksheet 53 to calculate the metrics and generate the dashboard. The riders available for adding to a financial services product, such as an insurance policy, may include a waiver rider or a child rider. The data in the discount and rider worksheet 53 may include usage and premium information for each category of rider. In one embodiment, the data in the discount and rider worksheet 53 may include a waiver usage, a waiver average premium, a child usage, and a child average premium. In one embodiment, the data in the discount and rider worksheet 53 may also include a discount assumption percent and a percent of discounts. Data from the discount and rider worksheet 53 may be pasted into a Mini-tab™ file to generate the control charts tool 48.

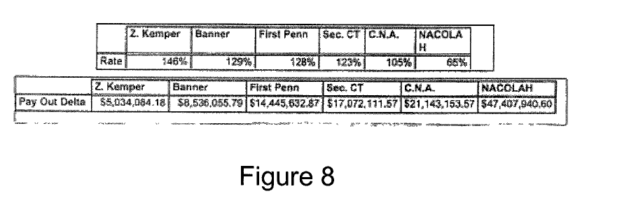

The commissions worksheet 54 may be used to generate a commissions market comparison metric. FIG. 8 is an illustration of one embodiment of the commissions worksheet 54. A premium delta, calculated using volume queries, and the market database file 28 may be pasted into the commissions worksheet 54. In one embodiment, the market database file 28 may be used to determine competitors' commission rates. Those rates may be imported into the commissions worksheet 54 to generate a commissions graph.

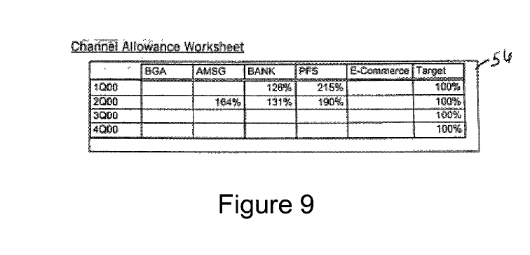

The channel allowance worksheet 56 may be used to produce an allowance dashboard. FIG. 9 illustrates the channel allowance worksheet 56 according to one embodiment of the present invention. The data in the channel allowance worksheet 56 may include how much each sales channel is spending relative to its product allowance. For example, the channel allowance worksheet 56 may include for each sales channel a series of columns and the quarters of the year as rows, as shown in FIG. 9. The entries for each sales channel for each quarter may include the percent of the sales channel's spending relative to its allowance. The channel allowance worksheet 56 may also include the target allowance for a particular sales channel for each quarter.

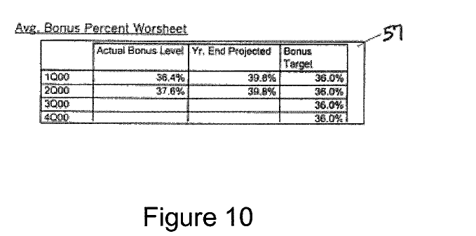

The bonus level worksheet 57 may include data from a bonus schedule file 49. FIG. 10 is an illustration of the bonus level worksheet 57 according to one embodiment of the present invention. The bonus level worksheet 57 may include columns indicating an actual bonus level, a year-end projected bonus level and a target bonus level. The rows may indicate the quarters of a year.

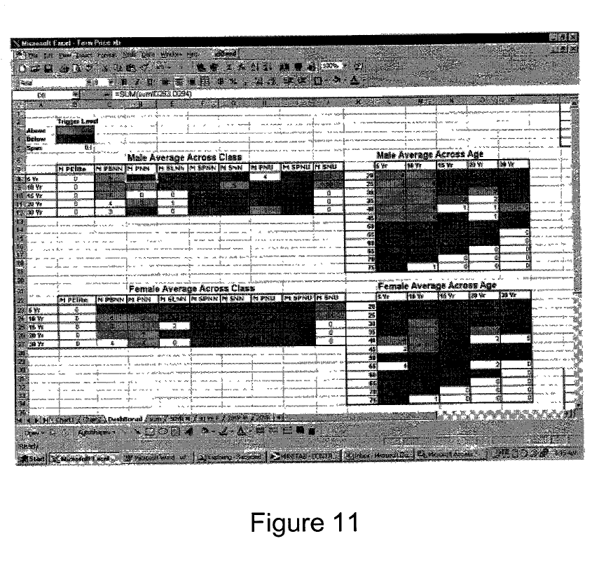

The product-price tool 45 may be a spreadsheet used to generate market gap metrics. In one embodiment, the product-price tool 45 file may be an Excel™ spreadsheet. FIG. 11 is a screen shot illustrating one embodiment of the product-price tool 45. The product-price tool 45 may be a workbook including several different types of worksheets within it. The product-price tool 45 may include a dashboard worksheet including an example of the competitive analysis dashboard on it. The dashboard may be linked to a sum worksheet including data comparing the company's price to a competitive market price throughout various cells. This worksheet may be used to generate all graphs in the product-price tool 45. The product-price tool 45 may also include worksheets containing the actual price data for each competitor or other companies. These worksheets may be used to do all the calculations and comparisons that are summarized on a sum worksheet. The charts and dashboard of the product-price tool 45 may be run from the data on the sum worksheet.

The dashboard worksheet 1101 may indicate product prices that are below the market price and product prices that are above the market price. In one embodiment, the prices above and below market price may be color-coded. In one embodiment, for a cell to change color, the value in the cell has to violate either of two criteria. In one embodiment, the criteria may be the average percent difference being greater or less than five percent (5%) or the span of the price range being greater than 10 percent (10%). The product-price tool 45 may also generate drill down charts run from the data on the sum worksheet.

The control charts tool 48 may be a minitab file used to generate control charts for the riders and the discounts. The data for the control charts tool 48 may be found in the waterfall dashboard 44 in the discounts and riders worksheets 53. A control chart may be created for each of the discounts and riders variables. In one embodiment, there may be six (6) discounts and riders variables.

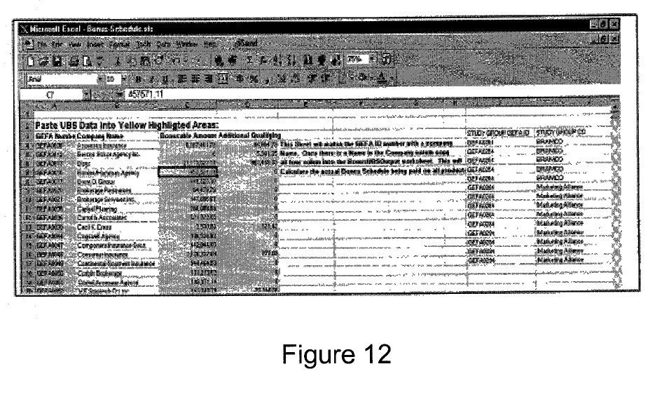

The bonus schedule tool 49 may also be a spreadsheet file, such as, for example, an Excel™ file. FIG. 12 is a screen shot illustrating one embodiment of the bonus schedule tool 49. The bonus schedule tool 49 may be used to analyze the company's bonus structure. The bonus schedule tool 49 may be set up to accept bonus payout data from the bonus system 13. In one embodiment, data from the bonus system 13 may be pasted into the bonus schedule tool 49.

In one embodiment, the bonus payout data may be received from the bonus system 13 in predetermined intervals. For example, the bonus payout data may be received quarterly. The bonus schedule tool 49 may also receive data from the term bonus data calculated in the waterfall dashboard 44 in the bonus level worksheet 57. A department, an agency or a company ID may be placed in a first column of the bonus schedule tool 49. The bonus amount and the additional qualifying amount may be placed in third and fourth columns of the bonus schedule tool 49. Once the data is in place, the department or company name may be found based on the identification number. This may be done using a lookup table taken from the pay level tool 43. Data columns may be copied and pasted into the bonus schedule tool 49 from the bonus system 13. The output from the bonus schedule tool 49 may indicate the an average bonus percent paid over a period for the data of the bonus system 13. Bonus data collected from the actuarial system 11 may also be placed into the bonus schedule tool 49 on a bonus calculation worksheet. In one embodiment, an average bonus percentage may be calculated based on product commissions. In one embodiment, a calculation may also be made to represent the estimated amount of production left for the rest of the year. This calculation may be changed as the year progresses.

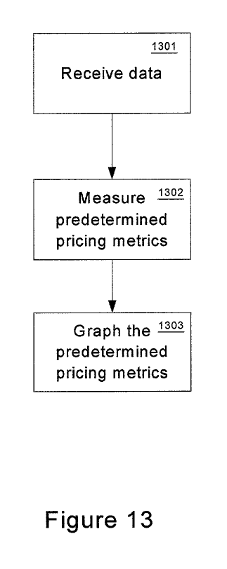

FIG. 13 is a flow diagram illustrating the steps performed in one embodiment of a method for analyzing a financial services pricing process. At a step 1301, data may be received from the systems 11-14. The data may be received in a plurality of input files 21-28. At step 1302, predetermined pricing metrics may be measured using the received data. The predetermined pricing metrics may include a market gap, an underwriting, a discount amount, a rider amount, a commission amount, and a bonus amount. The measurement of the predetermined pricing metrics will be described below. At step 1303, the predetermined pricing metrics may be graphed to produce a waterfall, as illustrated in FIG. 6.

The waterfall output 30 may include a waterfall and a plurality of buckets illustrating premium revenue leakage. The waterfall output 30 may be generated using the input data as described above. The buckets may include a market gap bucket, an underwriting bucket, a discounts bucket, a riders bucket, a commissions bucket and a bonus bucket.

The market gap bucket may be an assessment of the company's prices of its products relative to the products of other companies in its market. The market gap bucket may calculate a delta or difference in premiums collected for sales of the company's products versus an average market price using the volume of sales of the company. To calculate the market gap, an average market price may be determined using data from competitors or other companies in the market. The list of companies from which data is obtained may be updated as the market changes and competitors enter and exit the market. The price of each of the competitors' or other companies' products may be averaged together.

In one embodiment, this process may be performed using the product-price tool 45, where the products of the competitors and other companies may be compared. Sales volume data may be copied into a spreadsheet to calculate the amount of premiums collected for each risk class and age group of insured persons buying insurance products.

In one embodiment, a face amount for each of the policies sold may be an average of the face amounts of policies sold for each risk class. This average may be used to calculate the premiums collected. In another embodiment, the sales volume may be segmented into premium bands which limit the range used to calculate the average and allow additional capability in segmenting the price data. In one embodiment, the market database file 28 may be linked to a waterfall database file which may include sales volume information. Using the database queries described above, the data may be sorted to provide a product price, a risk class, an age and a sex of an insured person purchasing a policy, a premium band, a sales volume, an average face amount of a policy type, a company ID, an average price, a percent difference, a premium delta and a rank. The sum of the premium delta column may be the value of the market gap bucket. The sum of all of the values above the market price and all of the values below the market price may also be calculated. In one embodiment, this data may be calculated in the product-price tool 45.

The market gap metric may be calculated using the data fields as shown above. The percent difference from the market and the competitive rank may be calculated for each individual product, risk class and premium band. Using the database, this data may be sorted to give information by product group. This data may then be pasted into a worksheet to generate the market data graphs and dashboards. In one embodiment, the market data graphs and dashboards may be generated using the product-price tool 45.

The underwriting metric of the waterfall output 30 may show the amount of premium leakage experienced by an insurer across the insurer's entire product line. For example, for an insurance policy product, premium leakage may be caused by reclassification of the insured person's risk class. This reclassification may cause the company to collect less premiums on a higher risk insured person. The first year premium difference between what is being collected and what should have been collected may be classified as premium leakage. To obtain this information, a semiannual underwriting audit may be performed across all product underwriting locations. A statistically valid sample of insurance policies may be reviewed to determined an underwriting error rate and an amount of premium leakage caused by this rate. An underwriting committee may compile this information at the end of each audit cycle. An error rate and the premium leakage for each individual site as well as overall product trade may be provided. This data may be placed into the waterfall dashboard 44 in the underwriting worksheet 52 to generate the underwriting dashboard. The overall premium leakage number may be calculated and placed on the waterfall output 30.

The waterfall discount buckets or pricing metrics may include a total dollar amount of discounts granted by the insurer during a predetermined time period. This number may be calculated using the actuarial database. In one embodiment, all of the discounted policies may be encoded with an identifier in the plan code. For example, all of the discounted policies may be coded with a “S” in the plan code. A query may be used to sort the discounted policies and calculate the total value of discounts given. This value may be placed on the waterfall output 30. The discount metric analyzed may include the usage percentage over time. This data may be extracted from the actuarial data 21 using the alternate issue date, i.e., the date the policy was put into force on the system. Using the date conversion tool 46, the alternate issue date may be converted into a month and a quarter. Linking the .csv version of the this file with the waterfall database may enable policies to be sorted based on the month and quarter the policy was issued. This data may then be copied into the waterfall dashboard 44.

The discount and rider worksheet 53 may be used to calculate the discount usage percentage on a monthly basis. This percentage may then be graphed against the pricing assumption percentage of discount. Thus, it may be possible to determine if the discount assumed percentage was exceeded at any point during the period. The discount percentage data may also be copied into the control charts tool 48. An individual moving range control chart may be generated using the discount percentage data. This moving range control chart may enable a determination of the variation between the mean and the discount usage percentage to be made. This chart may also allow trends to be spotted in the usage rate when the rate moves three standard deviations away from the mean.

The rider bucket or pricing metric may include a summation of the additional premiums being generated by the sale of riders to issued insurance policies. This information may be obtained using the actuarial database. An access query using the subphase field may be used to sort the different types of riders available. For example, an access query using the subphase field may sort out all of the waiver riders or the child riders. Once the types of riders are separated, they may be sorted by month, in the same fashion as the discounts above. This data may then be copied into the waterfall dashboard 44 to generate the dashboards. The data may also be copied into the control chart tool 48 to generate the control charts.

The commissions bucket or pricing metric may include a calculation of all of the commissions paid by the insurer on the policies issued within a given period. This data may be obtained from the commissions system 12. In one embodiment, the data may provide an annualized amount for each policy. The commission data may be sorted in the waterfall database 40. The commission data file 22 may give the commission paid for each policy and the selling agent. In one embodiment, the commission data may be calculated using the actuarial data 21. Database queries may be used to sort the policies by plan and calculate the commissionable premiums and the paid commissions. The total commission amounts may be determined and entered into the waterfall output 30. Renewal commissions may also be calculated using the present value of premiums. Using a present value factor determined using pricing models, the present values of the premium income may be determined. In one embodiment, this number may be multiplied by an average renewal commission rate of 2.75%. This amount may also be placed on the waterfall in the commissions bucket. Two commission metrics may be monitored, a competitive payout rate vs. a company payout rate and a channel allowance. The competitive payout rate may show the insurance company's commission rate as it compares to those commission rates of its competitors. The competitive payout rate may also take the insurance company's sales volume over the applicable time period and calculate the difference in total commission payout at each of the competitors' commission rates. The data may then be sorted and placed into the waterfall dashboard 44 to generate the chart. The sales channel allowance may track how each individual sales channel managed its expense allowance for each individual insurance product.

The bonus bucket or pricing metric may include a summation of the bonuses paid by the insurer through the bonus system 13. In one embodiment, the bonus system 13 includes information as to each licensed broker's agency. Using the waterfall database 40, each insurance policy sold may be matched to a selling agent or broker who will be paid a commission for the sale. Using the institution roll-up map 25, the agency may be mapped to the sales level necessary for bonuses to be paid out by the insurance company. At a particular bonus level, the agencies may be grouped together and total commissions paid may be summed. This data may then be copied into the bonus schedule tool 49, which will calculate the bonuses. This bonus amount may be compared with the total bonus number that is pulled from the bonus system 13. The total bonus payout number may then be placed onto the waterfall output 30. The bonus metric may track an actual payout rate, a projected payout rate, and an assumed payout rate in the model. Each of these tracked rates may be tracked quarterly in the waterfall dashboard 44.

With each bucket defined, the waterfall output 30 may be generated. The waterfall output 30 may be based on a total amount of annualized premiums generated by the insurance company over a period of time. This total premium amount may include the invoice price and may be used as the basis for comparison of all of the buckets. Moving down the waterfall from the invoice price, one would subtract out commissions paid and bonuses paid to get pocket price to the insurance company. Moving up the waterfall from the invoice price, a back rider premium may be added and discounts and underwriting errors may be subtracted to obtain a list price. From here, the market gap may either be added or subtracted to get the market list price. All of the waterfall buckets are shown on the waterfall as a percentage of invoice price as shown in FIG. 5. The waterfall may be displayed in present value terms. The present value factor used to generate the initial waterfall may be predetermined. In one embodiment, the present value factor may be 7. This may be lowered slightly to represent a 13% discount rate. Once this present value factor is set, it should not be changed from quarter to quarter. In the waterfall dashboard 44, the waterfall worksheet 51 may be used to generate the waterfall. The total premium and commission amounts may be copied in from input 40 and the buckets may then be calculated. The waterfall dashboard 44 may be graphed from that data.

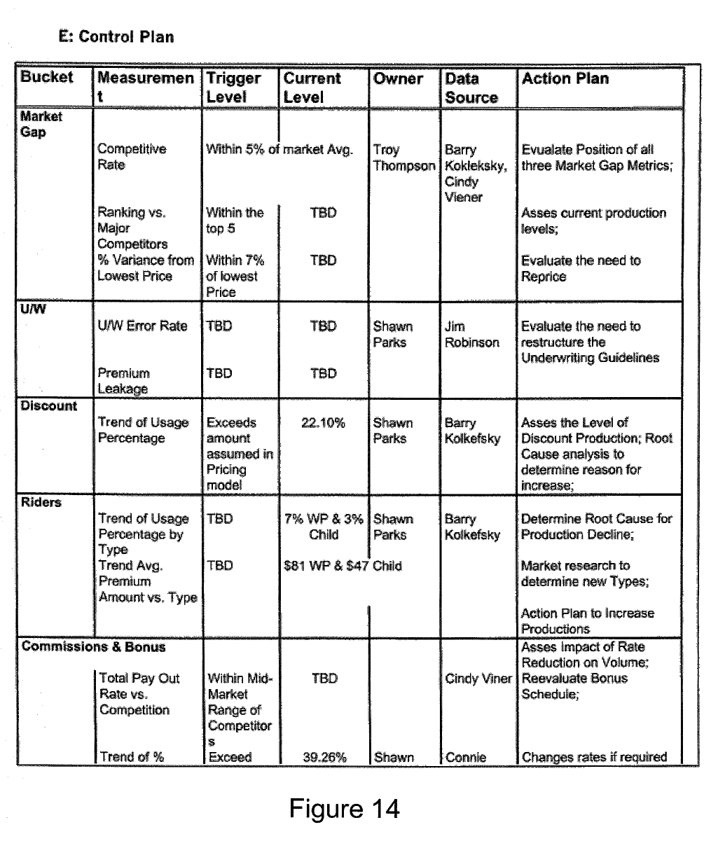

FIG. 14 is a chart describing a control plan according to one embodiment of the present invention. A control plan 1400 may be used to implement an action plan based on the measurements of the predetermined pricing metrics from the waterfall. In one embodiment, measurements and different aspects of the different buckets may trigger an action plan. For example, a trigger level may be set for each measurement in each of the buckets.

In the market bucket, measurements may include a competitive rate, a ranking vs. major competitors, and a percentage variance from a lowest price. In one embodiment, if the competitive rate is within 5% of a market average, an action plan of evaluating the position of all three (3) market gap metrics may be triggered. If ranking vs. the major competitors is within the top five (5), an action plan of assessing the current sales levels may be triggered. In one embodiment, if the percentage variance from the lowest price is within 7% of the lowest price, an action plan of evaluating the need to re-price insurance products may be triggered.

In the underwriting bucket, the measurements may include an underwriting error rate and a premium leakage. An action plan of evaluating a need to restructure the insurer's underwriting guidelines may be triggered if the underwriting error rate or premium leakage reach a specified trigger level.

Measurement of the discount bucket may include a trend of usage percentage. An action plan may be triggered if the trend of usage percentage exceeds the amount assumed in a pricing model. In one embodiment, an action plan may be to assess the level of discounts granted by the insurer. In another embodiment, an action plan may be to perform a root cause analysis to determine the reason for an increase in discounts granted.

The rider bucket may include measurements of trends of usage percentage by type and a trend average premium amount vs. type. Action plans that may be triggered by these measurements include determining a root cause for sales decline, conducting market research to determine new types and action plans to increase sales.

The commission and bonus buckets may include measurements of total commission payout rate vs. competition. If the total commission payout rate vs. competition is within a mid-market range of the competitors, an action plan for assessing the impact of commission rate reduction on sales volume and re-evaluating bonus schedules may be triggered. If the trend of percentage exceeds competitors, an action plan of changing the rates if required may be triggered.

The inventions described herein may a computer system for implementation of the financial services pricing process using a computer, a network and other resources. According to one embodiment of the invention, the analysis of the financial services pricing process is provided via the computer system in response to a processor in the computer system executing one or more sequences of one or more instructions contained in a main memory of the computer. Such instructions may be read into the main memory from another computer-readable medium, such as a storage device. Execution of the sequences of instructions contained in the main memory causes the processor to perform the process steps described herein. One or more processors in a multi-processing arrangement may also be employed to execute the sequences of instructions contained in the main memory. In alternative embodiments, hard-wired circuitry may be used in place of, or in combination with, software instructions to implement the invention. Thus, embodiments of the invention are not limited to a specific combination of hardware circuitry and software.

The term “computer-readable medium” as used herein refers to any medium that participates in providing instructions to the processor for execution. Such a medium may take many forms including but not limited to, a non-volatile media, a volatile media, and a transmission media. The non-volatile media may include a dynamic memory, such as the main memory. The transmission media may include a plurality of coaxial cables, a copper wire and fiber optics, including the wires that comprise a bus. The transmission media can also take the form of acoustic waves or light waves, such as those generated during radio frequency (RF) and infrared (IR) data communications. Common forms of a computer-readable medium include, for example, a floppy disk, a flexible disk, a hard disk, a magnetic tape, a CD-ROM, a DVD, punch cards, a paper tape, any other physical medium with patterns of holes, a RAM, a PROM, an EPROM, a FLASH-EPROM, any other memory chip or cartridge, a carrier wave as described hereinafter, or any other medium from which a computer can read instructions.

Various forms of computer readable media may be involved in carrying one or more sequences of one or more instructions to the processor for execution. For example, the instructions may initially be borne on a magnetic disk of a remote computer. The remote computer can load the instructions into a dynamic memory and send the instructions over a telephone line using a modem. A modem local to the computer system can receive the data on the telephone line and can use an infrared transmitter to convert the data to an infrared signal. An infrared detector coupled to the bus can receive the data carried in the infrared signal and place the received data on the bus. The bus may carry the data to the main memory, from which the processor may retrieve and execute the instructions. The instructions received by the main memory may optionally be stored on a storage device as described herein, either before or after execution by the processor.

The computer system may also include a communication interface coupled to the bus. The communication interface provides a two-way data communication means coupling to a network link that is connected to a local network or another network. For example, the communication interface may be an integrated service digital network (ISDN) card or a modem to provide a data communication connection to a corresponding type of telephone line. As another example, the communication interface may be a local area network (LAN) card to provide a data communication connection to a compatible LAN. Wireless links may also be implemented. In any such implementation, the communication interface sends and receives electrical, electromagnetic or optical signals that carry digital data streams representing various types of information.

The network link typically provides data communication through one or more networks to other data devices. For example, the network link may provide a connection through a local network to a host computer, a server or to another data equipment operated by an Internet Service Provider (ISP) or another entity. The ISP in turn may provide data communication services through the world wide packet data communication network, now commonly referred to as the “Internet.” The local network and the Internet both use electrical, electromagnetic or optical signals that carry digital data streams. The signals through the various networks and the signals on the network link and through the communication interface, which carry the digital data to and from the computer system, are exemplary forms of carrier waves transporting the information.

The computer system can send messages and receive data, including program code, through the network(s), the network link, and the communication interface. In the Internet example, a server might transmit a requested downloaded application for an application program through the Internet, the ISP, the local network and the communication interface. In accordance with the invention, one such downloaded application provides for operating and maintaining the pricing process analyzing system described herein. The received requested downloaded application may be executed by the processor as it is received, or it may be stored in a storage device or other non-volatile storage for later execution. In this manner, the computer system may obtain the requested downloaded application via a carrier wave or other communications.

Other embodiments, uses and advantages of the present invention will be apparent to those skilled in the art from consideration of the specification and practice of the invention disclosed herein. The specification and examples should be considered exemplary only. The intended scope of the invention is only limited by the claims appended hereto.

What is claimed is:

1. A method for analyzing a financial services pricing process, comprising the steps of:
receiving data from a plurality of sources in a tool; and
generating a waterfall including the sub-steps of
measuring predetermined pricing metrics using the received data, and
graphing the predetermined pricing metrics;
wherein the waterfall identifies the present value of each of the predetermined pricing metrics in relation to others of the predetermined pricing metrics.

2. The method of claim 1 wherein the step of measuring the predetermined pricing metrics includes measuring at least one of a discount, a plurality of incentives, a plurality of commissions, a plurality of fees, an underwriting and a market gap.

3. The method of claim 2 wherein the step of measuring the discount includes measuring a trend of usage percentage.

4. The method of claim 2 wherein the step of measuring the incentives includes measuring at least one of a total payout rate in relation to at least one payout rate of a competitor and a trend of usage percentage.

5. The method of claim 2 wherein the step of measuring the commissions comprises measuring at least one of a total payout rate in relation to at least one payout rate of a competitor and a trend of usage percentage.

6. The method of claim 2 wherein the step of measuring the fees includes measuring at least one of a trend of usage percentage by type and a trend in an average premium amount in relation to type.

7. The method of claim 2 wherein the step of measuring the underwriting includes measuring at least one of an underwriting error rate and a premium leakage.

8. The method of claim 2 wherein the step of measuring the market gap includes measuring at least one of a competitive rate, a ranking in relation to major competitors, and a percentage variance from a lowest price.

9. The method of claim 1 further comprising the step of implementing an action plan based on the measurements of the predetermined pricing metrics.

10. The method of claim 9 wherein the step of implementing the action plan includes implementing a control plan to automatically trigger the action plan when a measurement of a portion of one of the predetermined pricing metrics associated with the action plan meets a predetermined trigger level criteria.

11. The method of claim 9 wherein the step of measuring the predetermined pricing metrics includes measuring a market gap and the step of implementing the action plan includes at least one of evaluating a position of all market gap metrics, assessing current production levels and evaluating a need to re-price.

12. The method of claim 9 wherein the step of measuring the predetermined pricing metrics includes measuring an underwriting and the step of implementing the action plan includes evaluating a need to restructure underwriting guidelines.

13. The method of claim 9 wherein the step of measuring the predetermined pricing metrics includes measuring a discount and the step of implementing the action plan includes at least one of assessing a level of discount production and performing a root cause analysis to determine a reason for an increase.

14. The method of claim 9 wherein the step of measuring the predetermined pricing metrics includes measuring fees and the step of implementing the action plan includes at least one of determining a root cause for a production decline, performing market research to determine new fee types and implementing an action plan to increase production.

15. The method of claim 9 wherein the step of measuring the predetermined pricing metrics includes measuring commissions and the step of implementing the action plan includes at least one of assessing an impact of a rate reduction on volume, reevaluating a bonus schedule and implementing rate changes if required.

16. The method of claim 9 wherein the step of measuring the predetermined pricing metrics includes measuring a bonus and the step of implementing the action plan includes at least one of assessing an impact of a rate reduction on volume, reevaluating a bonus schedule and implementing rate changes if required.

17. The method of claim 1 wherein the step of receiving the data includes receiving the data from at least one of an actuarial system, a commissions system, a bonus system and a competitive analysis database.

18. The method of claim 1 wherein the step of receiving the data includes receiving at least one of policy information, commissions data, bonus information, and market data.

19. The method of claim 1 wherein the step of receiving the data in the tool includes receiving the data in at least one of an actuarial data file, a commissions data extract file, a bonus data file, an institution rollup map file, a date conversion file, a plan code conversion file and a market database.

20. The method of claim 1 further comprising the step of reviewing a pricing process using the waterfall generated.

21. The method of claim 1 further comprising the step of identifying opportunities to decrease revenue leaks using the waterfall generated.

22. The method of claim 1 wherein the pricing metrics are defined at a policy level.

23. The method of claim 1 wherein the step of measuring the at least one predetermined pricing metrics includes summarizing and sorting the received data in the database using a plurality of predetermined database queries.

24. A system for analyzing a financial services pricing process, comprising:
means for receiving data from a plurality of sources in a tool; and
means for generating a waterfall including
means for measuring a plurality of predetermined pricing metrics using the received data, and
means for graphing the predetermined pricing metrics;
wherein the waterfall identifies a present value of each of the predetermined pricing metrics in relation to others of the predetermined pricing metrics.

25. The system of claim 24 wherein the means for measuring the predetermined pricing metrics include means for measuring at least one of a discount, a plurality of incentives, a plurality of commissions, a plurality of fees, an underwriting and a market gap.

26. The system of claim 25 wherein the means for measuring the discount includes means for measuring a trend of usage percentage.

27. The system of claim 24 wherein the means for measuring the incentives includes at least one of a means for measuring a total payout rate in relation to a payout rate of at least one competitor and a means for measuring a trend of usage percentage.

28. The system of claim 24 wherein the means for measuring the commissions includes at least one of a means for measuring a total payout rate in relation to a payout rate of at least one competitor and a means for measuring a trend of usage percentage.

29. The system of claim 24 wherein the means for measuring the fees includes at least one of a means for measuring a trend of usage percentage by type and a means for measuring a trend average premium amount in relation to type.

30. The system of claim 24 wherein the means for measuring the underwriting includes means for measuring at least one of an underwriting error rate and a premium leakage.

31. The system of claim 24 wherein the means for measuring the market gap includes means for measuring at least one of a competitive rate, a ranking in relation to major competitors, and a percentage variance from a lowest price.

32. The system of claim 23 further comprising means for implementing an action plan based on the measurements of the predetermined pricing metrics.

33. The system of claim 31 wherein the means for implementing the action plan includes means for implementing a control plan to automatically trigger the action plan when the measurement of a portion of one of the predetermined pricing metrics associated with the action plan meets a predetermined trigger level criteria.

34. The system of claim 31 wherein the means for measuring the at least one predetermined pricing metric includes means for measuring a market gap and the means for implementing the action plan includes at least one of a means for evaluating a position of all market gap metrics, a means for assessing current production levels and a means for evaluating a need to re-price.

35. The system of claim 31 wherein the means for measuring the predetermined pricing metrics includes means for measuring an underwriting and the means for implementing the action plan includes means for evaluating a need to restructure underwriting guidelines.

36. The system of claim 31 wherein the means for measuring the predetermined pricing metrics includes means for measuring a discount and the means for implementing the action plan includes at least one of a means for assessing a level of discount production and a means for performing a root cause analysis to determine a reason for an increase.

37. The system of claim 31 wherein the means for measuring the predetermined pricing metrics includes means for measuring fees and the means for implementing the action plan includes at least one of a means for determining a root cause for a production decline, a means for performing market research to determine new fee types and a means for implementing an action plan to increase production.

38. The system of claim 31 wherein the means for measuring the predetermined pricing metrics includes means for measuring commissions and the means for implementing the action plan includes at least one of a means for assessing an impact of a rate reduction on volume, a means for reevaluating a bonus schedule and a means for implementing rate changes if required.

39. The system of claim 31 wherein the means for measuring the predetermined pricing metrics includes means for measuring a bonus and the means for implementing the action plan includes at least one of a means for assessing an impact of a rate reduction on volume, a means for reevaluating a bonus schedule and a means for implementing rate changes if required.

40. The system of claim 24 wherein the means for receiving the data includes means for receiving the data from at least one of an actuarial system, a commissions system, a bonus system and a competitive analysis database.

41. The system of claim 24 wherein the means for receiving the data includes means for receiving at least one of policy information, commissions data, bonus information, and market data.

42. The system of claim 24 wherein the means for receiving the data in the plurality of input files includes means for receiving the files in at least one of an actuarial data file, a commission data extract file, a bonus data file, an institution rollup map file, a date conversion file, a plan code conversion file and a market database.

43. The system of claim 24 further comprising means for reviewing a pricing process using the waterfall generated.

44. The system of claim 24 further comprising means for identifying opportunities to decrease revenue leaks using the waterfall generated.

45. The system of claim 24 wherein the predetermined pricing metrics are defined at a policy level.

46. A method for analyzing a financial services pricing process comprising the steps of:
receiving data in at least one input file of a pricing process summary tool from at least one data source;
processing the received data using at least one data analysis tool of the pricing process summary tool;
generating a pricing process summary including the sub-steps of
measuring a plurality of predetermined pricing metrics, and
graphing the predetermined pricing metrics;
wherein the pricing process summary identifies a present value of each of the predetermined pricing metrics in relation to others of the predetermined pricing metrics.

47. The method of claim 45 wherein the step of receiving the data in at least one input file of the pricing process summary tool includes receiving the data in at least one of an actuarial data file, a commission data extract file, a bonus data file, an institution rollup map file, a date conversion file, a plan code conversion file and a market database.

48. The method of claim 45 wherein the step of processing the data using at least one data analysis tool includes processing the data using at least one of a pay level tool, a date conversion tool, a price processing summary dashboard, a plan code conversion tool, a product-price tool, a plurality of control charts and a-bonus schedule tool.

49. The method of claim 47 wherein the step of processing the data using the price processing summary dashboard includes processing the data using at least one of a price processing summary worksheet, a discount and a rider worksheet, a commissions worksheet, an average bonus percentage worksheet and a channel allowance worksheet.

50. The method of claim 45 wherein the step of receiving the data from at least one data source includes receiving the data from at least one of an actuarial system, a commissions system, a bonus system, and a competitive analysis system.

51. A system for analyzing a financial services pricing process, comprising:
means for receiving data in at least one input file of a pricing process summary tool from at least one data source;
means for processing the received data using at least one data analysis tool of the pricing process summary tool;
means for generating a pricing process summary including
means for measuring a plurality of predetermined pricing metrics, and
means for graphing the predetermined pricing metrics;
wherein the pricing process summary identifies a present value of each of the predetermined pricing metrics in relation to others of the predetermined pricing metrics.

52. The system of claim 50 wherein the means for receiving the data in at least one input file of the pricing process summary tool includes means for receiving the data in at least one of an actuarial data file, a commission data extract file, a bonus data file, an institution rollup map file, a date conversion file, a plan code conversion file and a market database.

53. The system of claim 50 wherein the means for processing the received data using at least one data analysis tool includes means for processing the received data using at least one of a pay level tool, a date conversion tool, a price processing summary dashboard, a plan code conversion tool, a product-price tool, control charts and a bonus schedule tool.

54. The system of claim 52 wherein the means for processing the received data using the price processing summary dashboard includes means for processing the received data using at least one of a price processing summary worksheet, a discount and a rider worksheet, a commissions worksheet, an average bonus percentage worksheet and a channel allowance worksheet.

55. The system of claim 50 wherein the means for receiving the data from at least one data source includes means for receiving the data from at least one of an actuarial system, a commissions system, a bonus system, and a competitive analysis system.

56. A system for analyzing a financial services pricing process, comprising:
at least one financial services system having pricing process related data; and
a price process summary tool including a price process summary dashboard for generating a price processing summary to identify a present value of each of a plurality of predetermined price metrics based on the pricing process related data in relation to other of the plurality of predetermined price metrics.

57. The system of claim 55 wherein the price process summary dashboard includes at least one of a price process summary worksheet, a discount and a rider worksheet, a commissions worksheet, an average bonus worksheet and a channel allowance worksheet.

58. The system of claim 55 wherein the at least one financial services system includes at least one of an actuarial system, a commissions system, a bonus system, and a competitive analysis system.

59. The system of claim 57 wherein the competitive analysis system includes a competitive analysis database.

60. The system of claim 55 wherein the price process summary tool includes at least one input file for receiving the price process related data from the at least one financial services system.

61. The system of claim 59 wherein the at least one input file includes at least one of an actuarial data file, a commissions data file, a bonus data file, a cyberlife data file, an institution rollup map, a date conversion file, a plan code conversion file and a market database.

62. The system of claim 55 wherein the price processing summary tool further comprises at least one of a pay level tool, a date conversion tool, a plan-code conversion tool, a product-price tool, control charts and a bonus schedule tool.
